(19) United States
(12) Patent Application Publication
(10) Pub. No.: US 2014/0170880 A1
(43) Pub. Date: Jun. 19, 2014

(54) LOCK SYSTEM

(71) Applicant: KABUSHIKI KAISHA TOKAI RIKA DENKI SEISAKUSHO, Aichi (JP)

(72) Inventors: Yosuke DOI, Aichi (JP); Akihito KIMURA, Aichi (JP); Tadayuki TOBIMATSU, Aichi (JP); Keiji YAMAMOTO, Aichi (JP); Takashi IEDA, Aichi (JP)

(73) Assignee: KABUSHIKI KAISHA TOKAI RIKA DENKI SEISAKUSHO, Aichi (JP)

(21) Appl. No.: 14/088,892

(22) Filed: Nov. 25, 2013

(30) Foreign Application Priority Data
Dec. 13, 2012 (JP) 2012-272504

(51) Int. Cl. H01R 13/639

(52) U.S. Cl. CPC H01R 13/6395
USPC 439/305

(57) ABSTRACT

A lock system includes a lock device arranged in at least a vehicle. The lock device includes a lock member movable between a lock position and an unlock position. The lock device locks a lock subject to the vehicle when the lock member is located at the lock position and unlocks the lock subject when the lock member is located at the unlock position. A controller, which performs power line communication, includes a request output unit that transmits an operation request to the lock device by performing the power line communication to switch the lock subject between a locked state and an unlocked state. The lock device includes a lock control unit that receives the operation request from the controller and controls movement of the lock member based on the operation request.

### CROSS-REFERENCE TO RELATED APPLICATIONS

This application is based upon and claims the benefit of priority from prior Japanese Patent Application No. 2012-272504, filed on Dec. 13, 2012, the entire contents of which are incorporated herein by reference.

### FIELD

The present invention relates to a lock system that locks and unlocks a lock subject such as a charge cable.

### BACKGROUND

Vehicles that emit less carbon dioxide, such as plugin hybrid vehicles and electric vehicles, are environment-friendly and have become popular. Such a vehicle is powered by a battery. When the battery drains after driving the vehicle over a long distance, the battery is recharged. The body of the vehicle is provided with a power port. A charge cable of a charging facility is connected to the power port to supply power from the charging facility and charge the battery. The battery charging takes a long time. A charge cable lock device may be used to lock the charge cable to the vehicle body and prevent theft of the charge cable. Japanese Laid-Open Patent Publication No. 2009-081917 describes an example of a charge cable lock device.

The charge cable lock device of the above publication is locked when, for example, the vehicle door is locked. In this case, however, a user needs to approach the vehicle and lock the vehicle door to lock the charge cable. Thus, the locking of the charge cable is inconvenient.

### SUMMARY

One aspect of the present invention is a lock system. The lock system includes a lock device arranged in at least a vehicle. The lock device includes a lock member movable between a lock position and an unlock position. The lock member locks a lock subject to the vehicle when located at the lock position, and unlocks the lock subject when the lock member is located at the unlock position. The lock system further includes a controller that performs power line communication. The controller includes a request output unit that transmits an operation request to the lock device by performing the power line communication to switch the lock subject between a locked state and an unlocked state. The lock device includes a lock control unit that receives the operation request from the controller and controls movement of the lock member based on the operation request.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating one embodiment of a lock system;

FIG. 2 is a diagram illustrating the operation of the lock system illustrated in FIG. 1 when locking a charge cable;

FIG. 3 is a diagram illustrating the operation of the lock system illustrated in FIG. 1 when unlocking the charge cable; and

FIG. 4 is a schematic diagram illustrating a further example of a lock system.

### DESCRIPTION OF THE EMBODIMENTS

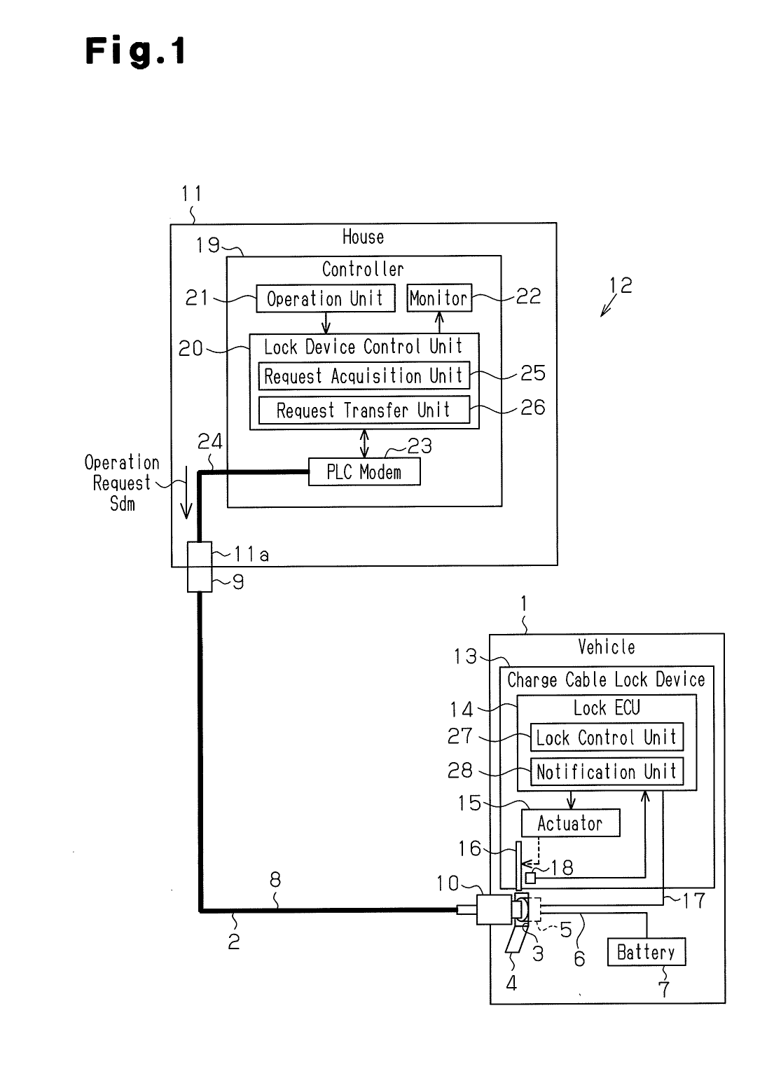

One embodiment of a lock system 12 will now be described with reference to FIGS. 1 to 3.

Referring to FIG. 1, a vehicle 1, such as a plugin hybrid vehicle or an electric vehicle, includes a power port 3, which is provided in a side wall of the vehicle body, and a lid 4, which opens and closes the power port 3. The power port 3 serves as a connection port for a charge cable 2. The power port 3 includes an inlet 5 that serves as a power reception connector. An in-vehicle power line 6 connects the inlet 5 to a battery 7. The charge cable 2 includes a cable line 8, a house-side plug 9, which is connectable to a connector 11a arranged in a house 11, and a power plug 10, which is connectable to the inlet 5. The charge cable 2 is one example of a lock subject.

The lock system 12 locks the charge cable 2, which is connected between the vehicle 1 and the house 11, to the inlet 5 to restrict unauthorized removal of the charge cable 2 from the inlet 5. For example, the power port 3 includes a charge cable lock device 13 that is capable of locking the charge cable 2 to the inlet 5. The charge cable lock device 13 includes a lock electronic control unit (ECU) 14, which controls to switch between the locking and unlocking of the charge cable 2, an actuator 15, which serves as a drive source, and a lock pin 16, which may be hooked to the charge cable 2. An in-vehicle signal line 17 connects the lock ECU 14 to the inlet 5. The lock ECU 14 controls the actuator 15 to move the lock pin 16 between a lock position and an unlock position, thereby switching the charge cable 2 between a locked state and an unlocked state. The charge cable lock device 13 is one example of a lock device. The lock pin 16 is one example of a lock member.

A lock detector 18, which detects the operational state of the charge cable lock device 13, that is, whether the charge cable 2 is in the locked state or the unlocked state, is connected to the lock ECU 14. The lock detector 18 detects whether the lock pin 16 is located at the lock position or the unlock position by, for example, directly monitoring the location of the lock pin 16 or monitoring the location of a member related with the lock pin 16. The lock detector 18 is, for example, at least a sensor or a switch that detects the lock position and/or the unlock position. Alternatively, the lock detector 18 may be an encoder that detects the operational amount of the actuator 15.

A controller 19 is arranged in the house 11 to control the operation of the charge cable lock device 13. The controller 19 includes a lock device control unit 20, an operation unit 21 such as a keyboard, a monitor 22, and a power line communication (PLC) modem 23. The controller 19 is realized by, for example, a personal computer. A power line 24, which is arranged in the house 11, connects the PLC modem 23 to the connector 11a. Power line communication (PLC) is a technique for performing data communication through the power line 24.

The lock system 12 performs power line communication to remotely control the charge cable lock device 13 with the controller 19 from the house 11 and lock or unlock the charge cable 2. The lock device control unit 20 includes a request acquisition unit 25 and a request transfer unit 26. The request acquisition unit 25 acquires an operation request Sdm for the charge cable lock device 13 based on, for example, a user operation. The request transfer unit 26 transmits the operation request Sdm acquired by the request acquisition unit 25 to the vehicle 1 through power line communication. The request acquisition unit 25 and the request transfer unit 26 form one example of functional blocks that configure a request output unit.

The lock ECU 14 includes a lock control unit 27 and a notification unit 28. The lock control unit 27 receives the operation request Sdm from the controller 19 through power line communication and controls the charge cable lock device 13 based on the operation request Sdm. The notification unit 28 notifies the controller of the operational state of the charge cable lock device 13, that is, whether the charge cable 2 is in the locked state or the unlocked state.

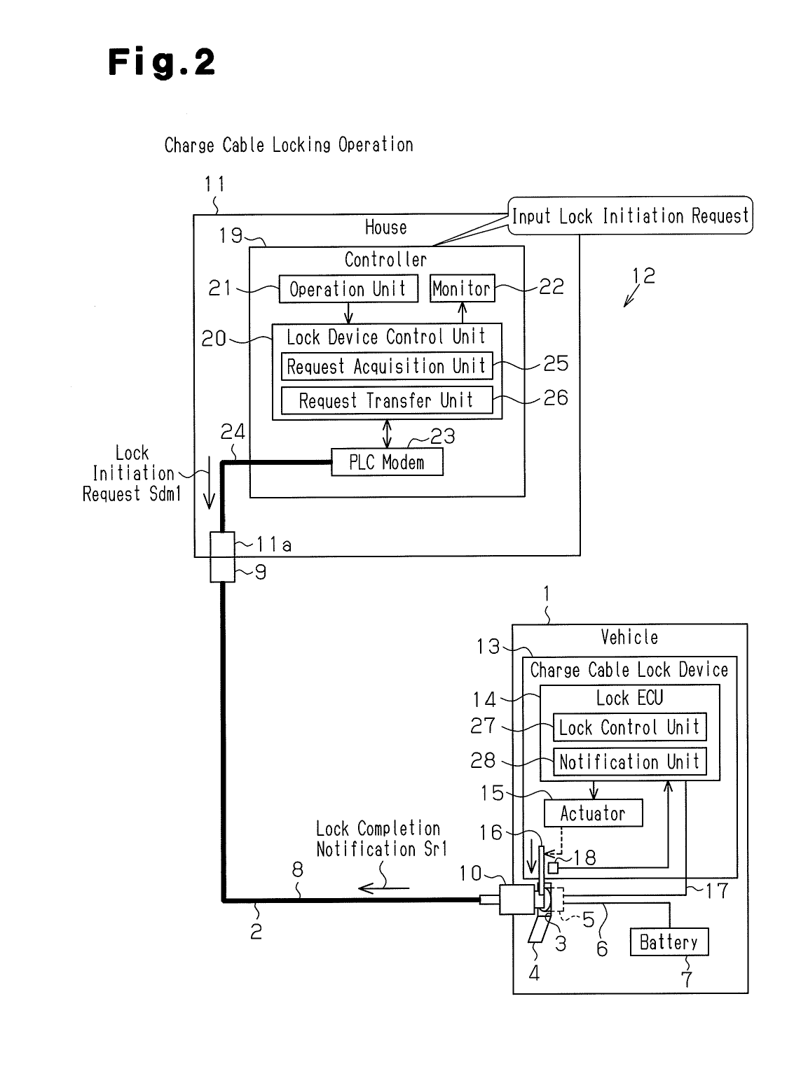

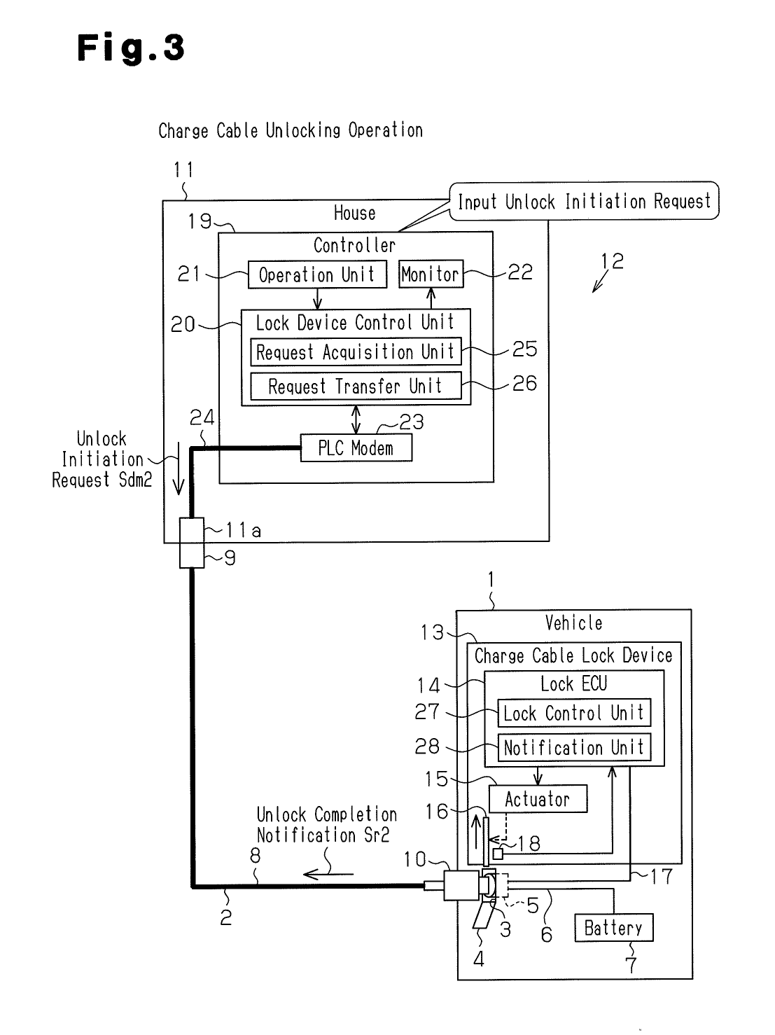

The operation of the charge cable lock device 13 will now be described with reference to FIGS. 2 and 3.

[Charge Cable Lock Operation]

As illustrated in FIG. 2, when locking the charge cable 2 from the house 11, the user operates the operation unit 21 while viewing an input screen illustrated on the monitor 22 of the controller 19 to input a lock initiation request command, a vehicle code designating the vehicle 1, and the like. The lock device control unit 20 acquires data of the lock initiation request command with the request acquisition unit 25. The request transfer unit 26 transfers the data of the lock initiation request command as a lock initiation request Sdm1 to the vehicle 1 through the power line 24 and the charge cable 2, that is, through power line communication. The lock initiation request Sdm1 includes, for example, the lock initiation command and the vehicle code.

The lock ECU 14 receives the lock initiation request Sdm1 through the inlet 5 and the in-vehicle signal line 17. In this case, the power line communication performed between the charge cable lock device 13 and the controller 19 may be encrypted. The lock control unit 27 acquires and verifies the vehicle code of the locked initiation request Sdm1. When the vehicle code is verified, the lock control unit 27 permits the charge cable lock device 13 to perform a locking operation.

When the locking operation is permitted, the lock control unit 27 controls the actuator 15 to move the lock pin 16 from the unlock position to the lock position. This hooks the lock pin 16 to the charge cable 2 connected to the inlet 5 and locks the charge cable 2. Accordingly, a person other than the user cannot remove the charge cable 2 from the inlet 5 in an unauthorized manner.

The lock detector 18 detects that the charge cable 2 has been switched to the locked state and provides the notification unit 28 with a detection signal (lock detection signal). In response to the lock detection signal, the notification unit 28 transfers a lock completion notification Sr1 to the controller 19 through the in-vehicle signal line 17, the charge cable 2, and the power line 24, that is, through power line communication. When receiving the lock completion notification Sr1, the controller 19, for example, shows a message on the monitor 22 to notify the user that the locking was normally completed.

[Charge Cable Unlock Operation]

As illustrated in FIG. 3, when unlocking the charge cable 2 from the house 11, the user operates the operation unit 21 while viewing an input screen illustrated on the monitor 22 of the controller 19 to input an unlock initiation request command, the vehicle code designating the vehicle 1, and the like. The lock device control unit 20 acquires data of the unlock initiation request command with the request acquisition unit 25. The request transfer unit 26 transfers the data of the unlock initiation request command as an unlock initiation request Sdm2 to the vehicle 1 through the power line 24 and the charge cable 2, that is, through power line communication. The unlock initiation request Sdm2 includes, for example, the unlock initiation command and the vehicle code.

The lock ECU 14 receives the unlock initiation request Sdm2 through the inlet 5 and the in-vehicle signal line 17. In this case, the power line communication performed between the charge cable lock device 13 and the controller 19 may be encrypted. The lock control unit 27 acquires and verifies the vehicle code of the unlock initiation request Sdm2. When the vehicle code is verified, the lock control unit 27 permits the charge cable lock device 13 to perform an unlocking operation.

When the unlocking operation is permitted, the lock control unit 27 controls the actuator 15 to move the lock pin 16 from the lock position to the unlock position. This separates the lock pin 16 from the charge cable 2 and unlocks the charge cable 2. Thus, removal of the charge cable 2 from the inlet 5 is allowed.

The lock detector 18 detects that the charge cable 2 has been switched to the unlocked state and provides the notification unit 28 with a detection signal (unlock detection signal). In response to the unlock detection signal, the notification unit 28 transfers an unlock completion notification Sr2 to the controller 19 through the in-vehicle signal line 17, the charge cable 2, and the power line 24, that is, power line communication. When receiving the unlock completion notification Sr2, the controller 19, for example, shows a message on the monitor 22 to notify the user that the unlocking was normally completed.

The present embodiment has the advantages described below.

(1) The controller 19, which is arranged in the house 11, is connected to the PLC modem 23, which is used to perform power line communication, to remotely control the charge cable lock device 13 of the vehicle 1 through power line communication. This configuration allows for the controller 19 to remotely control the charge cable lock device 13 and switch the charge cable 2 between locked and unlocked states. Thus, the user does not have to go to the vehicle 1 to switch the operational state of the charge cable lock device 13. Further, even when the user forgets to lock the charge cable 2 when moving away from the vehicle 1, the user may lock the charge cable 2 from the house 11. This improves the operation convenience.

(2) After locking the charge cable 2, the lock control unit 27 transmits the lock completion notification Sr1 to the controller 19. In response to the lock completion notification Sr1, the controller 19 notifies the user that locking has been completed. In the same manner, after unlocking the charge cable 2, the lock control unit 27 transmits the unlock completion notification Sr2 to the controller 19. In response to the unlock completion notification Sr2, the controller 19 notifies the user that unlocking has been completed. This configuration allows for the user to acknowledge whether or not the operation of the charge cable lock device 13 has been correctly completed. For example, the user may acknowledge that he or she forgot to lock the charge cable or has erroneously unlocked the charge cable 2. This improves the antitheft effect of the charge cable 2.

(3) The charge cable 2 is used as a line for power line communication. Thus, there is no need to prepare a separate power line connecting the house 11 and the vehicle 1. This decreases the number of wires connecting the vehicle 1 and the house 11.

It should be apparent to those skilled in the art that the present invention may be embodied in many other specific forms without departing from the spirit or scope of the invention. Particularly, it should be understood that the present invention may be embodied in the following forms.

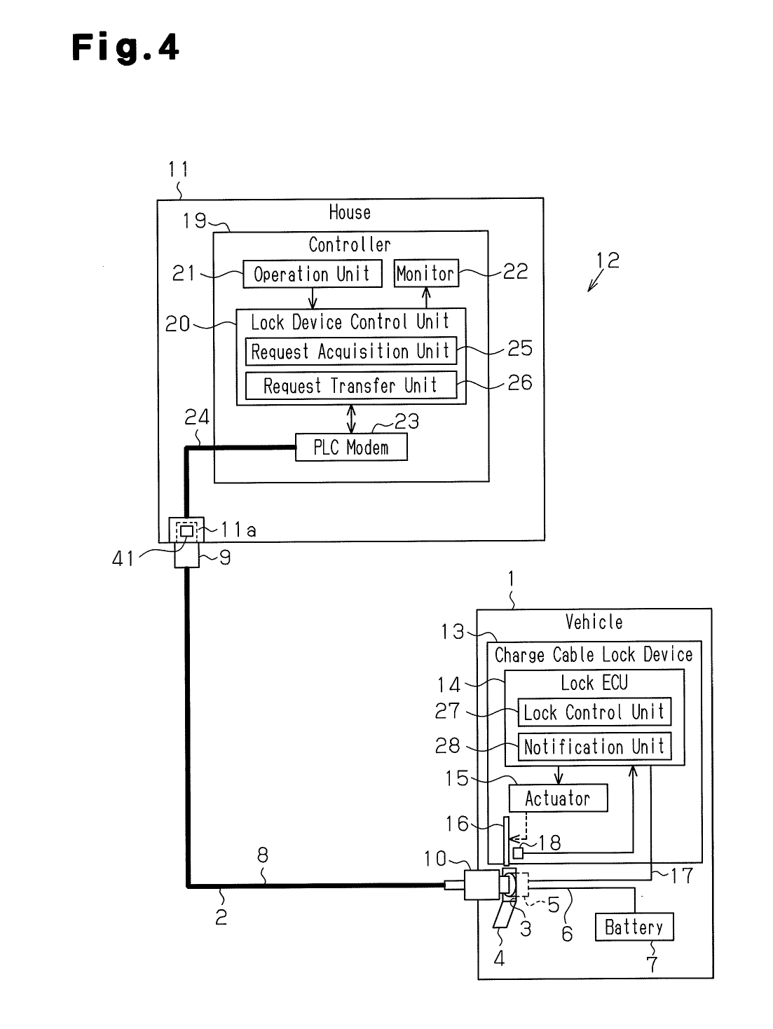

As illustrated in FIG. 4, a charge cable lock device 41 may be arranged in a connector 11a of the house 11. The charge cable lock device 41 has a configuration similar to that of the charge cable lock device 13 in the above embodiment. In this configuration, the lock device 13 may lock the power plug 10, which is arranged on one end of the charge cable 2, to the vehicle 1 (inlet 5), and the lock device 41, which is arranged on the other end of the charge cable 2, may lock the house-side plug 9, which is arranged on the other end of the charge cable 2, to the house 11 (connector 11a). In other words, in the system of FIG. 4, the charge cable 2 includes a first end and a second end, the charge cable lock device 13 is cable of locking the first end of the cable 2 to the vehicle 1, and the charge cable lock device 41 is cable of locking the second end of the cable 2 to the facility in which the controller 19 is arranged (in the above embodiment, the house 11). In this case, both ends of the charge cable 2 may be locked. This further increases the antitheft effect of the charge cable 2.

For example, in the lock system 12 illustrated in FIG. 4, the charge cable lock devices 13 and 41 may both be simultaneously operated in response to a single operation request Sdm. However, the charge cable lock devices 13 and 41 do not have to be simultaneously operated, and the charge cable lock devices 13 and 41 may be separately controlled by the controller 19.

The controller 19 does not have to be arranged in the house 11 and may be arranged in a different location.

The charge cable lock device 13 does not have to be arranged in the vehicle 1 and may be arranged in, for example, one end of the charge cable 2.

When an error occurs, for example, when a hooking error of the lock pin 16 occurs, the lock ECU 14 may notify the controller 19 of the error by outputting an answer back signal from the charge cable lock device 13.

A notification may be sent from the lock ECU 14 to the controller 19 by transmitting the present operational state (locked or unlocked state) from the charge cable lock device 13 to the controller 19 in response to an operation state inquiry from the controller 19.

The controller 19 does not have to be a personal computer and may be any terminal capable of performing power line communication.

The actuator of the charge cable lock device 13 may be a motor, a solenoid, or the like.

In the charge cable lock device 13, one of locking and unlocking may be performed manually, and the other one of locking and unlocking may be electrically controlled.

The structure of the charge cable lock device 13 may be changed as long as it is capable of switching the change cable 2 between locked and unlocked states. For example, the lock member does not have to be the lock pin 16 that moves straight and may be a cylindrical member that is rotatable and includes a cutout portion engageable with the charge cable 2. Further, the lock member may be a triangular plate pivoted between a lock position and an unlock position.

The charge cable lock device 13 may include an urging member that urges the lock pin 16, or lock member, to the lock position or the unlock position. For example, when an urging member urges the lock member to the unlock position, the actuator 15 moves the lock member to the lock position against the urging force of the urging member. When the urging member urges the lock member to the lock position, the actuator 15 moves the lock member to the unlock position against the urging force of the urging member.

The charge cable lock device 13 may include a support member directly connected to the lock pin 16 and driven to move the lock pin 16 between the lock position and the unlock position. For example, the lock pin 16 may include a projection, and a cylindrical support member may include a sloped groove. The support member is rotatable, and the projection of the lock pin 16 may be supported to be slidable in the groove. In this structure, when the support member rotates, the projection moves along the groove and moves the lock pin 16 between the lock position and the unlock position.

The power plug 10 of the charge cable 2 may include a lock arm that is capable of being hooked to the inlet 5 (e.g., projection of the inlet 5). For example, the lock arm may be pivotally arranged on the power plug 10. In this case, the charge cable lock device 13 may be configured to restrict pivoting of the lock arm, which is hooked to the inlet 5, with a lock pin 16, or lock member. This also keeps the charge cable 2 locked.

Alternatively, the charge cable lock device 13 may directly hook the lock pin 16, or the lock member, to a housing (main portion) of the power plug 10 in order to lock the charge cable 2.

The present invention is not limited to only using the lock device as the charge cable lock device 13. For example, the lock device may be used as a lid lock device that locks the lid 4 of the power port 3 by hooking the lock pin 16 to a striker projecting from the lid 4. In this case, the lid 4 corresponds to a lock subject. Alternatively, a single lock device may be used to selectively perform either one of charge cable locking and lid locking. This simplifies the device.

The charge cable lock device 13 may be switched to only one of a locking state and an unlocking state through power line communication.

The present examples and embodiments are to be considered as illustrative and not restrictive, and the invention is not to be limited to the details given herein, but may be modified within the scope and equivalence of the appended claims.

1. A lock system comprising:
a lock device arranged in at least a vehicle and including a lock member movable between a lock position and an unlock position, wherein the lock device is configured to lock a lock subject to the vehicle when the lock member is located at the lock position and unlock the lock subject when the lock member is located at the unlock position; and
a controller capable of performing power line communication and including a request output unit that transmits an operation request to the lock device by performing the power line communication to switch the lock subject between a locked state and an unlocked state,
wherein the lock device includes a lock control unit that receives the operation request from the controller and controls movement of the lock member based on the operation request.

2. The lock system according to claim 1, wherein
the lock device further includes a notification unit that transmits the present operational state of the lock device to the controller through the power line communication, and
the controller is configured to be capable of notifying a user of the present operational state.

3. The lock system according to claim 1, wherein
the lock subject is a charge cable connectable to the vehicle,
the lock device is a charge cable lock device that locks the charge cable to the vehicle, and
the controller is connected to the charge cable lock device by a power line, which is arranged in a house, and the charge cable, which connects the power line and the vehicle so that the controller transmits the operation request to the charge cable lock device through the power line and the charge cable.

4. The lock system according to claim 1, wherein
the lock subject is a charge cable connectable to the vehicle,
the lock device is a charge cable lock device that locks the charge cable to the vehicle,
the charge cable includes a first end and a second end,
the charge cable lock device serves as a first charge cable lock device capable of locking the first end of the charge cable to the vehicle, and
the lock system further comprises a second charge cable lock device capable of locking the second end of the charge cable to a facility in which the controller is arranged.

5. The lock system according to claim 1, wherein
the controller is arranged in a house and configured to remotely control the lock device from the house by performing the power line communication to move the lock member between the lock position and the unlock position.

6. The lock system according to claim 1, wherein
the lock subject is a lid that is configured to be capable of opening and closing a power port of the vehicle,
the lock device is a lid lock device that locks the lid to the power port.
